(19) United States
(12) Patent Application Publication
(10) Pub. No.: US 2021/0163762 A1
(43) Pub. Date: Jun. 3, 2021

(54) Dispersion Liquid, Coating Liquid, and Heat Ray Shielding Film

(71) Applicant: Sumitomo Osaka Cement Co., Ltd., Chiyoda-ku, Tokyo (JP)

(72) Inventor: Masahiro Nobe, Chiyoda-ku, Tokyo (JP)

(21) Appl. No.: 15/780,146

(22) PCT Filed: Apr. 20, 2017
(86) PCT No.: PCT/JP2017/015851

§ 371 Date: May 30, 2018

(30) Foreign Application Priority Data
Dec. 27, 2016 (JP) 2016-254271

(51) Int. Cl. C09D 5/32; C09D 17/00; C09D 7/61; C09D 175/14; C01G 30/02

(52) U.S. Cl. CPC C09D 5/32; C09D 17/007; C08K 2003/2282; C09D 175/14; C01G 30/026; C09D 7/61

(57) ABSTRACT

A dispersion liquid contains antimony-doped tin oxide (ATO) particles and a solvent, a content of the antimony-doped tin oxide particles is 40% by mass or more, a volume average particle diameter of the antimony-doped tin oxide particles is 90 nm or less, and, in a color space by the L*a*b* color system, an L* value is 13.0 or less, an a* value is −2.0 or more and 0.0 or less, and a b* value is −13.0 or more and −10.0 or less.

### TECHNICAL FIELD

The present invention relates to a dispersion liquid, a coating liquid, and a heat ray shielding film.

### BACKGROUND ART

Hitherto, in the fields of buildings represented by houses, vehicles represented by cars, and the like, for the purpose of the improvement of habitability and the saving of energy, a heat ray shielding film having a function of shielding (reflecting or absorbing) heat rays that are emitted from sunlight has been attached to house window glass and car windshields.

Examples of functions and performance abilities that are demanded for the heat ray shielding film include a high visible light-transmitting property, a high heat ray (near infrared rays through middle infrared rays)-shielding property, and the like. In addition, for car windshields or building window glass through which people see objects in a long distance, a high transparency is also required.

As the heat ray shielding film, generally, heat ray shielding films obtained by dispersing inorganic particles that reflect or absorb heat rays in a transparent resin such as an acrylic resin, a methacrylic resin, an epoxy resin, a urethane resin, or a polyester resin are used.

Examples of the inorganic particles include antimony-doped tin oxide (ATO) particles, tin-doped indium oxide (ITO) particles, cesium-doped tungsten oxide (CWO) particles, lanthanum hexaboride (LaB₆) particles, aluminum-doped zinc oxide (AZO) particles, and the like. Among them, antimony-doped tin oxide particles are frequently used from the viewpoints of performance abilities and cost.

For antimony-doped tin oxide particles for obtaining a heat ray shielding film as described above, a dispersion liquid for forming a heat ray shielding film, and a heat ray shielding preliminary film, it has been proposed to regulate the crystallite diameter, specific surface area, powder color, or the like of the antimony-doped tin oxide particles (for example, refer to Patent Literature 1).

### CITATION LIST

### Patent Literature

[Patent Literature No. 1] Japanese Laid-open Patent Publication No. 2004-83397

### SUMMARY OF INVENTION

### Technical Problem

However, even in a case in which the above-proposed antimony-doped tin oxide particles satisfy a variety of characteristics such as the crystallite diameter, the specific surface area, and the powder color, when the degree of dispersion is not sufficient in the production of a dispersion liquid, there has been a problem in that a high visible light transmittance, a low solar transmittance, and a low haze value, which are desired, cannot be obtained in a case in which a heat ray shielding film has been produced.

Therefore, there is a demand for a dispersion liquid, a coating liquid, and a heat ray shielding film which are capable of satisfying all of a higher visible light transmittance, a lower solar transmittance, and a lower haze value.

Therefore, an object of the present invention is to solve the above-described variety of problems in the related art and achieve the following object. That is, an object of the present invention is to provide a dispersion liquid and a coating liquid capable of forming a heat ray shielding preliminary film having a low solar transmittance while guaranteeing a high visible light transmittance and a heat ray shielding film having a low solar transmittance while guaranteeing a high visible light transmittance.

### Solution to Problem

Means for achieving the above-described object is as described below. That is,

<1> A dispersion liquid containing antimony-doped tin oxide (ATO) particles and a solvent,

in which a content of the antimony-doped tin oxide particles is 40% by mass or more,

a volume average particle diameter of the antimony-doped tin oxide particles is 90 nm or less, and,

in a color space by the L*a*b* color system, an L* value is 13.0 or less, an a* value is −2.0 or more and 0.0 or less, and a b* value is −13.0 or more and −10.0 or less.

<2> A coating liquid containing antimony-doped tin oxide (ATO) particles, a polymerizable compound, and a solvent,

in which a content of the antimony-doped tin oxide particles is 40% by mass or more and 60% by mass or less with respect to a non-volatile component, and,

in a color space by the L*a*b* color system, an L* value is 21.0 or less, an a* value is −3.0 or more and 0.0 or less, and a b* value is −14.0 or more and −12.0 or less.

<3> A heat ray shielding film containing antimony-doped tin oxide (ATO) particles,

in which a haze value is 1.0% or less, and,

when a visible light transmittance is 80% or more, a ratio between a solar transmittance (%) and the visible light transmittance (%) (the solar transmittance/the visible light transmittance) is 0.81 or less.

<4> The heat ray shielding film according to <3> having a heat ray shielding layer containing the ATO particles and a cured substance of a polymerizable compound, in which a content of the ATO particles in the heat ray shielding layer is 40% by mass or more and 60% by mass or less.

### Advantageous Effects of Invention

According to the present invention, it is possible to solve the above-described variety of problems in the related art and achieve the above-described object, and it is possible to provide a dispersion liquid and a coating liquid capable of forming a heat ray shielding preliminary film having a low solar transmittance while guaranteeing a high visible light transmittance and a heat ray shielding film having a low solar transmittance while guaranteeing a high visible light transmittance.

### DESCRIPTION OF EMBODIMENTS

(Dispersion Liquid)

A dispersion liquid of the present invention contains at least antimony-doped tin oxide (ATO) particles (hereinafter, in some cases, referred to as “ATO particles”) and a solvent and further contains other components as necessary.

The content of the ATO particles in the dispersion liquid is 40% by mass or more.

The volume average particle diameter of the ATO particles in the dispersion liquid is 90 nm or less.

In the dispersion liquid, in the color space by the L*a*b* color system, the L* value is 13.0 or less, the a* value is −2.0 or more and 0.0 or less, and the b* value is −13.0 or more and −10.0 or less.

The present inventors carried out studies for obtaining the dispersion liquid of the present invention which is a dispersion liquid capable of forming a heat ray shielding preliminary film having a low solar transmittance while guaranteeing a high visible light transmittance. As a result, the present inventors could obtain the dispersion liquid of the present invention by optimizing dispersion conditions (the kind of a disperser, the size of a dispersion medium, the concentration of ATO particles, the kind and amount of a surface modifier, the kind and amount of a dispersant, the kind and amount of a solvent, and the like) of ATO particles and completed the present invention.

<ATO Particles>

The antimony-doped tin oxide (ATO) particles are not particularly limited and can be appropriately selected depending on the purpose.

The content of antimony in the ATO particles is not particularly limited, and can be appropriately selected depending on the purpose, but is preferably 0.5% by mass or more and 20% by mass or less and more preferably 5% by mass or more and 12% by mass or less.

The average primary particle diameter of the ATO particles is not particularly limited, and can be appropriately selected depending on the purpose, but is preferably 3 nm or more and 60 nm or less, and more preferably 5 nm or more and 40 nm or less. When the average primary particle diameter of the ATO particles is 3 nm or more and 60 nm or less, it becomes easy to set to the volume average particle diameter (D50) of the ATO particles in the dispersion liquid and a coating liquid and a heat ray shielding film which will be described below to 90 nm or less.

The average primary particle diameter refers to the average value of the particle diameters of the respective ATO particles.

Examples of a method for measuring the average primary particle diameter include a method in which the particle diameters of the respective ATO particles are measured using, for example, a scanning electron microscope (SEM), a transmission electron microscope (TEM), or the like, and the average value of the particle diameters is calculated. The number of the ATO particles being measured is preferably 100 or more and more preferably 500 or more.

The specific surface area of the ATO particles is not particularly limited, and can be appropriately selected depending on the purpose, but is preferably 20 m²/g or more and 90 m²/g or less and more preferably 40 m²/g or more and 80 m²/g or less. When the specific surface area of the ATO particles is 20 m²/g or more and 90 m²/g or less, it is possible to set the average primary particle diameter in the above-described range.

The specific surface area can be measured using a BET method, and, as a measurement instrument in the BET method, for example, BELSORP-miniII manufactured by MicrotracBEL Corp., ASAP 2020 manufactured by Shimadzu Corporation, or the like can be used.

The ATO particles may contain components other than antimony, tin, and oxygen. Other components are not particularly limited, and examples thereof include Si, B, F, P, and the like.

The volume average particle diameter (the median value D50 of dispersed particle diameters) of the ATO particles is 90 nm or less, preferably 75 nm or less, and more preferably 60 nm or less. When the volume average particle diameter is 90 nm or less, it is possible to suppress the scattering of visible light, and, in a heat ray shielding film that is produced using the dispersion liquid, the haze value can be set to 1.0% or less.

The lower limit value of the volume average particle diameter is not particularly limited, can be appropriately selected depending on the purpose, and may be 10 nm.

The volume average particle diameter (the median value D50 of dispersed particle diameters) can be measured as the particle size distribution of dispersed particles in a dispersion body using a dynamic light scattering method or a laser diffraction and scattering method. Particularly, in a case in which the measurement subject is particles of nanometer sizes, a dynamic light scattering method is preferably used. The median value D50 which is the integrated percent value of dispersed particle diameters can be calculated from the obtained particle size distribution. As a measurement instrument of the particle size distribution using the dynamic light scattering method, for example, nano Partica SZ-100 manufactured by Horiba Ltd. Nanotrac Wave EX150 manufactured by Nikkiso Co., Ltd., or the like can be used.

Meanwhile, the volume average particle diameter is the average particle diameter of so-called secondary particles.

In the dispersion liquid, the integrated volume 90% particle diameter (hereinafter, expressed as D90) of the ATO particles is preferably 400 nm or less and more preferably 250 nm or less.

In addition, the lower limit value of D90 is not particularly limited, can be appropriately selected depending on the purpose, and may be 100 nm.

D50/D10 (the integrated volume 10% particle diameter) in the dispersion liquid is preferably 1.3 or more and 2.5 or less and more preferably 1.5 or more and 2.0 or less.

D10 and D90 can be obtained using, for example, a dynamic light scattering method. As a measurement instrument of the particle size distribution using the dynamic light scattering method, for example, nano Partica SZ-100 manufactured by Horiba Ltd. Microtrac 9340-UFA manufactured by Nikkiso Co., Ltd., or the like can be used.

The content of the ATO particles in the dispersion liquid is 40% by mass (w/w) or more, preferably 40% by mass or more and 65% by mass or less, and more preferably 45% by mass or more and 55% by mass or less. In a case in which the content of the ATO particles is less than 40% by mass, there is a concern that it may become impossible to add a sufficient amount of the ATO particles to a coating liquid described below when the coating liquid is produced using the dispersion liquid. On the other hand, when the content of the ATO particles exceeds 65% by mass, there is a case in which it becomes difficult to set the volume average particle diameter to 90 nm or less.

—Surface Modification of ATO Particles—

The surfaces of the ATO particles are preferably modified with a surface modifier from the viewpoint of improving the affinity or bonding property of a solvent described below and a polymerizable compound and a cured substance thereof and the viewpoint of dispersing the ATO particles in the solvent in a volume average particle diameter of 90 nm or less.

—Surface Modifier—

As the surface modifier, one or more selected from the group consisting of surfactants, alkoxysilane compounds, and metal alkoxides are preferably used.

As the surfactants, there are negative ion-based surfactants, positive ion-based surfactants, and non-ionic surfactants. These surfactants can be appropriately selected depending on the purpose.

Examples of the negative ion-based surfactants include aromatic phosphoric acid esters, aliphatic phosphoric acid esters, sulfuric acid esters, sodium polycarboxylate, ammonium polycarboxylate, furthermore, aliphatic acid sodium such as sodium oleate, sodium stearate, and sodium laurate, aliphatic acid-based surfactants such as aliphatic acid sodium, aliphatic acid potassium, and aliphatic acid ester sodium sulfonate, phosphoric acid-based surfactants such as sodium alkyl phosphate ester, olefin-based surfactants such as sodium alpha olefin sulfonate, alcohol-based surfactants such as sodium alkyl sulfate, alkyl benzene-based surfactants, and the like.

Examples of the positive ion-based surfactants include amine-based surfactants, imidazoline-based surfactants, quaternary ammonium cation-based surfactants, amide-type quaternary cationic surfactants, ester-type quaternary cationic surfactants, and the like.

Examples of the non-ionic surfactants include polyethylene glycol derivatives, aliphatic acid-based surfactants such as polyoxyethylene lanolin aliphatic acid ester, and polyoxyethylene sorbitan aliphatic acid ester, polyoxyethylene alkyl phenyl ethers, aliphatic acid alkanolamide, silicone-based surfactants, fluorine-based surfactants, and the like.

Examples of the alkoxysilane compounds include 3-glycidoxypropyl trimethoxysilane, 3-glycidoxypropyl triethoxysilane, p-styryl trimethoxysilane, p-styryl triethoxysilane, 3-acryloxypropyl trimethoxysilane, 3-acryloxypropyl triethoxysilane, 3-methacryloxypropyl trimethoxysilane, 3-methacryloxypropyl triethoxysilane, allyl trimethoxysilane, allyl triethoxysilane, vinyl ethyl dimethoxysilane, vinyl ethyl diethoxysilane, 3-glycidoxypropyl ethyl dimethoxysilane, 3-glycidoxypropyl triethyl diethoxysilane, p-styryl ethyl dimethoxysilane, p-styryl ethyl diethoxysilane, 3-acryloxypropyl ethyl dimethoxysilane, 3-acryloxypropyl ethyl diethoxysilane, 3-methacryloxypropyl ethyl dimethoxysilane, 3-methacryloxypropyl ethyl diethoxysilane, allyl ethyl dimethoxysilane, allyl ethyl diethoxysilane, vinyl diethyl methoxysilane, vinyl diethyl ethoxysilane, 3-glycidoxypropyl diethyl methoxysilane, 3-glycidoxypropyl diethyl ethoxysilane, p-styryl diethyl methoxysilane, p-styryl diethyl ethoxysilane, 3-acryloxypropyl diethyl methoxysilane, 3-acryloxypropyl diethyl ethoxysilane, 3-methacryloxypropyl diethyl methoxysilane, 3-methacryloxypropyl diethyl ethoxysilane, allyl diethyl methoxysilane, allyl diethyl ethoxysilane, and the like.

Examples of the metal alkoxide compounds include aluminum ethylate, aluminum isopropylate, aluminum-sec-butylate, aluminum diisopropylate mono-sec-butyrate, zirconium-n-butoxide, zirconium-tert-butoxide, tetra-n-butoxytin, tetra-tert-butoxytin, and the like.

Among these surface modifiers, particularly preferred alkoxysilane compound are silane coupling agents, particularly preferred metal alkoxides are aluminum alkoxide, and particularly preferred surfactants are negative ion-based surfactants. These surface modifiers can be appropriately selected depending on the purpose.

The surfactant, the alkoxysilane compound, and the metal alkoxide compound may be used singly, and two or more of them may be jointly used as long as there are no adverse influences between them.

The modification amount of the surface modifier is not particularly limited as long as a heat ray shielding layer produced by curing a coating liquid described below exhibits a sufficiently small haze value and satisfies a practical strength and can be appropriately selected.

Here, the modification amount of the surface modifier is preferably 0.2% by mass or more and 30% by mass or less, more preferably 0.5% by mass or more and 20% by mass or less, and particularly preferably 1% by mass or more and 15% by mass or less with respect to the total mass of the ATO particles.

<Solvent>

The solvent is not particularly limited, and can be appropriately selected depending on the purpose, but is preferably an organic solvent from the viewpoint of the solubility of a polymerizable compound when the dispersion liquid is used in a coating liquid described below. Meanwhile, in the present specification, the solvent refers to a liquid having a property of volatilizing after being applied to any substrate, and whether or not the solvent dissolves non-volatile components in the dispersion liquid or a coating liquid described below does not matter.

Examples of the organic solvent include aliphatic hydrocarbons such as hexane, heptane, and cyclohexane, aromatic hydrocarbons such as toluene and xylene, alcohols such as methanol, ethanol, and propanol, halogenated hydrocarbons such as ethylene chloride, ketones such as acetone, methyl ethyl ketone, methyl isobutyl ketone, 2-pentanone, and isophorone, esters such as ethyl acetate and butyl acetate, cellosolves such as ethyl cellosolve, ethers such as propylene glycol monomethyl ether and propylene glycol monoethyl ether, amide-based solvents, ether ester-based solvents, and the like. Among these organic solvents, it is preferable to select an organic solvent in which the polymerizable compound is favorably dissolved. The organic solvent may be used singly or two or more organic solvents may be jointly used.

The content of the solvent in the dispersion liquid is not particularly limited, and can be appropriately selected depending on the purpose, but is preferably 10% by mass or more and 60% by mass or less, more preferably 20% by mass or more and 55% by mass or less, and particularly preferably 30% by mass or more and 50% by mass or less.

<L*a*b*>

In the dispersion liquid, in the color space by the L*a*b* color system, the L* value is 13.0 or less, the a* value is −2.0 or more and 0.0 or less, and the b* value is −13.0 or more and −10.0 or less.

The L* value, the a* value, and the b* value are measurement values when the content of the ATO particles in the dispersion liquid is 40% by mass. Meanwhile, in a case in which the content of the ATO particles in the dispersion liquid is not 40% by mass, the dispersion liquid is appropriately diluted with the solvent or the like so as to set the content of the ATO particles to 40% by mass, and then the values are measured.

The L* value of the dispersion liquid is 13.0 or less, preferably 12.0 or less, more preferably 11.0 or less, and particularly preferably 10.0 or less.

In addition, the lower limit value of the L* value is not particularly limited, can be appropriately selected depending on the purpose, and may be 5.0.

The a* value of the dispersion liquid is −2.0 or more and 0.0 or less, preferably −1.5 or more and −0.5 or less, and more preferably −1.2 or more and −0.9 or less.

The b* value of the dispersion liquid is −13.0 or more and −10.0 or less, preferably −12.5 or more and −10.0 or less, and more preferably −12.5 or more and −10.2 or less.

The color space by the L*a*b* color system is one of the methods for displaying colors, was formulated in 1976 by International Commission on Illumination (CIE), and is a space in which the quantity of a stimulus of colored light that serves as a cause of a color sense is physically measured and expressed using brightness (L* value), the degree of magenta and green (a* value), and the degree of yellow and blue (b* value). The L* value of 0 indicates black, the L* value of 100 indicates white, the a* value of a negative value indicates a greenish color, the a* value of a positive value indicates a magenta-ish color, the b* value of a negative value indicates a bluish color, and the b* value of a positive value indicates a yellowish color.

A method for measuring the color space by the L*a*b* color system is regulated by Japanese Industrial Standards JIS Z 8781-4: 2013, and the color space can be measured using a spectral haze meter which is a measurement instrument according to the above-described measurement method, for example, SE2000 manufactured by Konica Minolta Inc., SD7000 manufactured by Nippon Denshoku Industries Co., Ltd., or the like.

As a method for preparing the dispersion liquid, for example, the ATO particles may be dispersed under conditions suitable to the dispersion of the ATO particles with reference to examples described below.

For example, a liquid mixture in which the ATO particles, the solvent, and the surface modifier are mixed together can be obtained using a method in which the components are mechanically mixed together using a mixing device. In addition, a liquid mixture in which the ATO particles that have been modified with the surface modifier in advance and the solvent are mixed together may be obtained using a method in which the components are mechanically mixed together using a mixing device.

Examples of the mixing device include a stirrer, a rotation and revolution-type mixer, a homogenizer, an ultrasonic homogenizer, a sand grinder, a ball mill, and the like.

(Coating Liquid)

A coating liquid of the present invention contains at least antimony-doped tin oxide (ATO) particles, a polymerizable compound, and a solvent and further contains other components as necessary.

The content of the ATO particles in the coating liquid is 40% by mass or more and 60% by mass or less with respect to a non-volatile component.

In the coating liquid, in the color space by the L*a*b* color system, the L* value is 21.0 or less, the a* value is −3.0 or more and 0.0 or less, and the b* value is −14.0 or more and −12.0 or less.

<Antimony-Doped Tin Oxide (ATO) Particles>

Examples of the ATO particles include the ATO particles exemplified in the section of the dispersion liquid of the present invention and the like. A preferred range thereof is also identical thereto.

The content of the ATO particles in the coating liquid is 40% by mass or more and 60% by mass or less, preferably 45% by mass or more and 60% by mass or less, and more preferably 50% by mass or more and 60% by mass or less with respect to a non-volatile component.

The non-volatile component refers to a remainder obtained by removing a volatile component from the coating liquid. The volatile component is, generally, a solvent and volatilizes when a coated film is produced from the coating liquid. Therefore, the mass of the non-volatile component is also the mass of a coated film when the coated film is produced from the coating liquid.

<Polymerizable Compound>

The polymerizable compound is a component for forming a transparent resin that serves as a matrix material in a heat ray shielding film described below, includes a monomer or an oligomer for forming the transparent resin, and is a non-cured substance having fluidity. From this viewpoint, the polymerizable compound is also referred to as a polymerizable component.

The scope of the polymerizable compound includes not only substances having a single molecular weight and a single chemical composition but also substances having a molecular weight distribution (for example, polymerizable oligomers and polymerizable polymers).

The transparent resin refers to, for example, a resin in which the average light transmittance in the entire visible light range, which is measured using the measurement method according to JIS K7361-1: 1997, is 80% or more. The average light transmittance in the entire visible light range is preferably 90% or more and more preferably 95% or more.

The polymerizable compound is not particularly limited as long as the polymerizable compound is a monomer or oligomer of a curable resin that is used for ordinary hardcoat films, a photocurable monomer or oligomer may be used, and a thermosetting monomer or oligomer may be used.

A photocurable monomer is preferably used since films having a high transparency and a strong hard coating property are easily obtained, and, among photocurable monomers, a crosslinkable compound having any one or both of one or more acryloyl groups and methacryloyl groups in the molecule is more preferably used. Hereinafter, there will be a case in which having any one or both of acryloyl groups and methacryloyl groups will be referred as (meth)acryloyl groups. What has been described above will also be true for acrylates and the like.

The crosslinkable compound having any one or both of one or more acryloyl groups and methacryloyl groups in the molecule is not particularly limited, but polyfunctional (meth)acrylates being excellent in terms of reactivity, transparency, weather resistance, and hardness are preferred. Here, being polyfunctional means having three or more functional groups. Three or more functional groups may be all the same kind of functional group or different kinds of functional groups.

Examples of functional groups other than the acryloyl group and the methacryloyl group that the crosslinkable compound has include a vinyl group, an ally group, an ally ether group, a styryl group, a hydroxyl group, and the like.

Specific examples of the polyfunctional (meth)acrylates include polyol polyacrylates such as trimethylolpropane triacrylate, ditrimethylolpropane tetraacrylate, pentaerythritol triacrylate, pentaerythritol tetraacrylate, and dipentaerythritol hexaacrylate, epoxy acrylates, polyester acrylates, urethane acrylates, polysiloxane acrylates, and the like, methacrylates thereof, and the like. The polyfunctional (meth)acrylate may be used singly or two or more polyfunctional (meth)acrylates may be used in a mixture.

The content of the polymerizable compound in the coating liquid is not particularly limited, and can be appropriately selected depending on the purpose, but is preferably 20% by mass or more and 55% by mass or less, more preferably 25% by mass or more and 50% by mass or less, and particularly preferably 30% by mass or more and 45% by mass or less with respect to the non-volatile component.

<Solvent>

The solvent is not particularly limited, and can be appropriately selected depending on the purpose, but is preferably an organic solvent from the viewpoint of the solubility of the polymerizable compound.

Examples of the organic solvent include aliphatic hydrocarbons such as hexane, heptane, and cyclohexane, aromatic hydrocarbons such as toluene and xylene, alcohols such as methanol, ethanol, and propanol, halogenated hydrocarbons such as methylene chloride, ethylene chloride, ketones such as acetone, methyl ethyl ketone, methyl isobutyl ketone, 2-pentanone, and isophorone, esters such as ethyl acetate and butyl acetate, cellosolves such as ethyl cellosolve, ethers such as propylene glycol monomethyl ether and propylene glycol monoethyl ether, amide-based solvents, ether ester-based solvents, and the like. Among these organic solvents, it is preferable to select an organic solvent in which the polymerizable compound is favorably dissolved. The organic solvent may be used singly or two or more organic solvents may be jointly used.

The content of the solvent in the coating liquid is not particularly limited, and can be appropriately selected depending on the purpose, but is preferably 20% by mass or more and 60% by mass or less, more preferably 30% by mass or more and 50% by mass or less, and particularly preferably 35% by mass or more and 45% by mass or less.

<Other Components>

The above-described other components are not particularly limited within the scope of the gist of the invention of the present application and can be appropriately selected depending on the purpose, and examples thereof include a dispersant, a polymerization initiator, an antistatic agent, a refractive index adjuster, an antioxidant, an ultraviolet absorber, a light stabilizer, a leveling agent, a defoaming agent, an inorganic filler, a coupling agent, a preservative, a plasticizer, a flow adjuster, a thickener, a pH adjuster, a polymerization initiator, and the like.

—Dispersant—

The dispersant is not particularly limited and can be appropriately selected depending on the purpose, and examples thereof include anionic surfactants such as sulfuric acid ester-based surfactants, carboxylic acid-based surfactants, and polycarboxylic acid-based surfactants, cationic surfactants such as amines, nonionic surfactants such as higher aliphatic acid polyethylene glycol ester-based surfactants, silicone-based surfactants, fluorine-based surfactants, polymeric surfactants having an amide ester bond, and the like. The dispersant may be used singly or two or more dispersants may be jointly used.

—Polymerization Initiator—

The polymerization initiator can be appropriately selected depending on the kind of the monomer and the oligomer that is used as the polymerizable compound. In the case of using a photocurable polymerizable compound, a photopolymerization initiator is used. The kind or amount of the photopolymerization initiator is appropriately selected depending on the photocurable polymerizable compound being used.

Examples of the photopolymerization initiator include benzophenone-based initiators, diketone-based initiators, acetophenone-based initiators, benzoin-based initiators, thioxanthone-based initiators, quinone-based initiators, benzyldimethylketal-based initiators, alkylphenone-based initiators, acylphosphine oxide-based initiators, phenylphosphine oxide-based initiators, and the like. The photopolymerization initiator may be used singly or two or more photopolymerization initiators may be jointly used.

The content of the photopolymerization initiator in the coating liquid is not particularly limited, and can be appropriately selected depending on the purpose, but is preferably 0.5% by mass or more and 20% by mass or less, more preferably 1.0% by mass or more and 15% by mass or less, and particularly preferably 3% by mass or more and 10% by mass or less with respect to the polymerizable compound.

—Thickener—

Preferred examples of the thickener include natural water-soluble polymers such as gelatin, casein, collagen, hyaluronic acid, albumin, and starch, semisynthetic polymers such as methyl cellulose, ethyl cellulose, methylhydroxypropyl cellulose, carboxymethyl cellulose, hydroxymethyl cellulose, hydroxypropyl cellulose, sodium carboxymethyl cellulose, and propylene glycol alginic acid ester, synthetic polymers such as polyvinyl alcohol, polyvinyl pyrrolidone, carbomers (carboxyvinyl polymers), polyacrylates, and polyethylene oxides, inorganic minerals such as bentonite, laponite, and hectorite, and the like. The thickener may be used singly or two or more thickeners may be jointly used.

A method for producing the coating liquid is not particularly limited and can be appropriately selected depending on the purpose, and the coating liquid can be obtained using a method in which the dispersion liquid of the present invention, the polymerizable compound, the polymerization initiator, and, as necessary, the solvent are mechanically mixed together using a mixing device.

Examples of the mixing device include a stirrer, a rotation and revolution-type mixer, a homogenizer, an ultrasonic homogenizer, and the like.

<L*a*b*>

In the coating liquid, in the color space by the L*a*b* color system, the L* value is 21.0 or less, the a* value is −3.0 or more and 0.0 or less, and the b* value is −14.0 or more and −12.0 or less.

The L* value, the a* value, and the b* value are measurement values when the content of the ATO particles in the coating liquid is 50% by mass with respect to the non-volatile component. Meanwhile, in a case in which the content of the ATO particles in the dispersion liquid is not 50% by mass, the content is adjusted using the polymerizable compound or the like so as to be set to 50% by mass, and then the values are measured.

The L* value of the coating liquid is 21.0 or less, preferably 20.0 or less, more preferably 19.0 or less, and particularly preferably 18.0 or less.

In addition, the lower limit value of the L* value is not particularly limited, can be appropriately selected depending on the purpose, and may be 10.0.

The a* value of the coating liquid is −3.0 or more and 0.0 or less, preferably −2.5 or more and −0.5 or less, and more preferably −2.5 or more and −1.0 or less.

The b* value of the coating liquid is −14.0 or more and −12.0 or less, preferably −13.7 or more and −12.0 or less, and more preferably −13.7 or more and −12.1 or less.

(Heat Ray Shielding Film)

A heat ray shielding film of the present invention contains antimony-doped tin oxide (ATO) particles.

In the heat ray shielding film, the haze value is 1.0% or less.

In the heat ray shielding film, when the visible light transmittance is 80% or more, the ratio between the solar transmittance (%) and the visible light transmittance (%) (the solar transmittance/the visible light transmittance) is 0.81 or less.

The heat ray shielding film has, for example, a heat ray shielding layer and a base material.

For example, the heat ray shielding layer is formed on the base material using the coating liquid of the present invention, thereby obtaining a heat ray shielding film in which the haze value is 1.0% or less, and the ratio between the solar transmittance (%) and the visible light transmittance (%) (the solar transmittance/the visible light transmittance) is 0.81 or less.

<Haze Value>

In the heat ray shielding film, the haze value is 1.0% or less. The haze value refers to the proportion (%) of diffused transmitted light in the entire transmitted light.

When the haze value is 1.0% or less, even in a case in which the heat ray shielding film is attached to a car windshield or a building window glass, there is no case in which a long landscape becomes blurred, and a favorable sight can be ensured.

The lower limit value of the haze value is not particularly limited, can be appropriately selected depending on the purpose, and may be 0.1%.

Generally, the haze value of a base material that is used in heat ray shielding films is less than 1.0%, and thus the heat ray shielding layer is extremely excellent in terms of transparency.

The haze value can be measured and obtained using the measurement method according to Japanese Industrial Standards JIS K 7136: 2000 and a haze meter, for example, NDH-2000 manufactured by Nippon Denshoku Industries Co., Ltd., HM-150 manufactured by Murakami Color Research Laboratory, or the like.

<Solar Transmittance (SLT) (%) and Visible Light Transmittance (VLT) (%)>

In the heat ray shielding film, when the visible light transmittance is 80% or more, the ratio between the solar transmittance (%) and the visible light transmittance (%) (the solar transmittance/the visible light transmittance) is 0.81 or less. When the ratio is 0.81 or less, it is possible to satisfy both a high visible light-transmitting property and a high heat ray-shielding property.

The lower limit value of the ratio is not particularly limited, can be appropriately selected depending on the purpose, and may be 0.6.

In order to maintain a favorable visibility, the visible light transmittance of the heat ray shielding film is preferably 50% or more, more preferably 70% or more, and particularly preferably 78% or more.

The upper limit value of the visible light transmittance is not particularly limited, and can be appropriately selected depending on the purpose, but is preferably 90%. When the visible light transmittance exceeds 90%, the heat ray-shielding effect becomes insufficient, which is not preferable.

The solar transmittance (%) and the visible light transmittance (%) can be obtained by measuring the heat ray shielding film using the measurement method according to Japanese Industrial Standards JIS $3107: 2013 and a spectral photometer, for example, U-4100 manufactured by Hitachi, Ltd., V-770 manufactured by JASCO Corporation, or the like.

<Base Material>

The base material needs to be a resin that transmits visible light rays, and examples thereof include polyester, polyethylene (PE), polypropylene (PP), polyamide (PA), polyvinyl chloride (PVC), polycarbonate (PC), polyvinyl alcohol (PVA), polymethyl methacrylate (PMMA), polyethylene terephthalate (PET), polyvinylidene fluoride (PVDF), polytetrafluoroethylene (PTFE), polychlorotrifluoroethylene (PCTFE), and the like. Among them, polyester films are preferred from the viewpoint of transparency, stability, costs, and the like, and, among the polyester films, a polyethylene terephthalate (PET) film is more preferred.

The form of the base material may be a sheet shape or a flexible film shape, but is preferably a film shape.

The average thickness of the base material can be appropriately selected depending on the material thereof, the use of heat ray shielding films to be formed, and the like and is, for example, preferably 25 μm or more and 200 μm or less, more preferably 25 μm or more and 100 μm or less, and particularly preferably 25 μm or more and 50 μm or less.

<Heat Ray Shielding Layer>

The heat ray shielding layer contains antimony-doped tin oxide (ATO) particles and a cured substance of a polymerizable compound and further contains other components as necessary.

The ATO particles are not particularly limited and can be appropriately selected depending on the purpose, and examples thereof include the ATO particles exemplified in the description of the dispersion liquid of the present invention and the like.

The content of the ATO particles in the heat ray shielding layer is not particularly limited, and can be appropriately selected depending on the purpose, but is preferably 40% by mass or more and 60% by mass or less, more preferably 45% by mass or more and 60% by mass or less, and particularly preferably 50% by mass or more and 60% by mass or less.

The polymerizable compound is not particularly limited, can be appropriately selected depending on the purpose, and examples thereof include the polymerizable compounds exemplified in the description of the coating liquid of the present invention and the like.

The content of the cured substance of the polymerizable compound in the heat ray shielding layer is not particularly limited, and can be appropriately selected depending on the purpose, but is preferably 20% by mass or more and 55% by mass or less, more preferably 25% by mass or more and 50% by mass or less, and particularly preferably 30% by mass or more and 45% by mass or less.

The heat ray shielding layer is obtained by, for example, curing the coating liquid.

A method for disposing the heat ray shielding layer on the base material using the coating liquid is not particularly limited and can be appropriately selected depending on the purpose, and examples thereof include ordinary wet coating methods such as a bar coating method, a spin coating method, a spray coating method, an ink jet method, a dip coating method, a roll coating method, a gravure coating method, a reverse roll coating method, a knife coating method, a screen printing method, and a kiss coating method, and the like.

A method for curing the coating liquid can be appropriately selected depending on the kind of the polymerizable compound that is included in the coating liquid.

For example, in a case in which the polymerizable compound is a thermosetting resin, it is possible to cure the coating liquid by heating the coating liquid at a temperature for a period of time that are high and long enough to cure this resin-forming component. In addition, in a case in which the polymerizable compound is a photocurable resin, it is possible to cure the coating liquid by irradiating the coating liquid with light having an energy high enough to cure the polymerizable compound for a predetermined period of time.

Meanwhile, in a case in which the coating liquid contains a volatile component such as a solvent, it is preferable to remove the volatile component in advance before the curing of the coating liquid. A method for removing the volatile component can be appropriately selected, a heat treatment in the atmosphere or under reduced pressure is preferred, and the conditions are 50° C. to 150° C. for approximately one minute to ten minutes.

The light used to cure the photocurable resin is not particularly limited as long as the light cures the film, and examples thereof include energy rays such as an ultraviolet ray, a near ultraviolet ray, a far-infrared ray, an infrared ray, an X-ray, a γ-ray, an electron beam, a proton ray, and a neutron ray. Among the above-described energy rays, an ultraviolet ray is preferred since the curing rate is fast, and it is easy to procure and handle devices.

A method for radiating the ultraviolet ray is not particularly limited and can be appropriately selected depending on the purpose, and examples thereof include a method in which an ultraviolet ray is radiated using a high-pressure mercury lamp, a metal halide lamp, a xenon lamp, a chemical lamp, or the like which generates ultraviolet rays in a wavelength range of 200 nm to 500 nm at an energy of 100 mJ/cm² to 3,000 mJ/cm², and the like.

The average thickness of the heat ray shielding layer can be appropriately selected depending on the material thereof, the use of heat ray shielding films to be formed, and the like, and is preferably 0.1 μm or more and 20 μm or less, more preferably 0.5 μm or more and 10 μm or less, and particularly preferably 1.0 μm or more and 5.0 μm or less.

In a case in which the ATO particles are surface-modified, the affinity or bonding property to the cured substance of the polymerizable compound improves, and thus it is easy for the ATO particles to be uniformly diffused and held in the heat ray shielding film, and thus the characteristics become uniform at the entire place in the heat ray shielding film. Therefore, the refractive index in the surface of the heat ray shielding film becomes almost uniform, and the occurrence of color unevenness in the heat ray shielding film is suppressed. In addition, the affinity or bonding property between the ATO particles and the cured substance of the polymerizable compound improves, and thus peeling or the like does not occur in the interfaces between the cured substance of the polymerizable compound and the ATO particles, and thus heat ray shielding films having a high strength or high abrasion resistance can be obtained.

The average thickness of the heat ray shielding film can be appropriately selected depending on the material thereof, the use of heat ray shielding films to be formed, and the like, and is preferably 25 μm or more and 220 μm or less, more preferably 25 μm or more and 120 μm or less, and more preferably 25 μm or more and 70 μm or less.

Due to the heat ray shielding film of the present invention, it is possible to provide heat ray shielding films which facilitate seeing objects in a long distance and have a high heat ray-shielding effect while guaranteeing a high visible light transmittance.

Therefore, when the heat ray shielding film of the present invention is applied to the surface of the like of a car windshield or a building window glass, it is easy to see objects in a long distance, transparency is excellent, and a sufficient heat ray-shielding property can be obtained.

### EXAMPLES

Hereinafter, examples of the present invention will be described, but the present invention is not limited to the following examples.

### Example 1

<Production of Dispersion Liquid 1>

Powder of antimony-doped tin oxide (ATO) particles 1 (T-1, manufactured by Mitsubishi Materials Electronic Chemicals Co., Ltd.: the powder characteristics are shown in Table 1) (50.0 parts by mass), aluminum-sec-butylate (manufactured by Kawaken Fine Chemicals Co., Ltd.) (5.0 parts by mass), an aromatic phosphoric acid ester surfactant (CS-141E, manufactured by ADEKA Corporation) (2.0 parts by mass), and toluene (43.0 parts by mass) were crushed and dispersed using a sand grinder (4TSG: manufactured by AIMEX Co., Ltd.) together with glass beads having a diameter of 0.1 mmφ at 2,500 rpm for four hours, thereby obtaining a dispersion liquid 1.

<Measurement of L*a*b*>

The obtained dispersion liquid 1 was diluted with toluene so that the content of the ATO particles reached 40% by mass, and the dispersion liquid (20 mL) was loaded into a colorless transparent glass cell having a flat bottom portion with a diameter of 30 mm. For the color tone of reflected light, the L*a*b* of the dispersion liquid 1 were measured at a two-degree view using a spectral haze meter (SE2000, manufactured by Konica Minolta Inc.) and a D65 light source on the basis of the measurement method according to Japanese Industrial Standards JIS Z 8781-4: 2013. The results are shown in Table 1.

<Measurement of Volume Average Particle Diameter (Median Value D50), D10, and D90>

As the volume average particle diameter of the ATO particles in the dispersion liquid 1, the median value D50 was obtained using a particle size distribution measurement instrument (Nonotrac Wave EX150, manufactured by Nikkiso Co., Ltd.) and a dynamic light scattering method and considered as the volume average particle diameter. In addition, D10 and D90 were also measured in the same manner. The results are shown in Table 1.

<Production of Coating Liquid 1>

The dispersion liquid 1 (63.0 parts by mass), a urethane acrylate resin (T-102, manufactured by Shin-Nakamura Chemical Co., Ltd.) (22.0 parts by mass), a photo initiator (IRGACURE 907, manufactured by BASF) (1.0 part by mass), toluene (5.0 parts by mass), and methyl isobutyl ketone (MIEK) (9.0 parts by mass) were mixed together, thereby obtaining a coating liquid 1. The coating liquid was adjusted using a urethane acrylate resin so that the content of the ATO particles in the coating liquid 1 reached 50% by mass with respect to the non-volatile component, and then the L*a*b* values were measured in the same manner as for the dispersion liquid 1. The results are shown in Table 2. Meanwhile, in the adjusted liquid of the coating liquid 1 in which the content of the ATO particles was set to 50% by mass with respect to the non-volatile component, the content of ATO was 30.3% by mass of the entire coating liquid.

<Production of Heat Ray Shielding Film 1>

The dispersion liquid 1 was applied to a polyethylene terephthalate film (A4300, manufactured by Toyobo Co., Ltd.) having an average thickness of 38 μm so that the film thickness of a heat ray shielding film after curing reached 3 μm and cured by being irradiated with 250 mJ/cm² of ultraviolet rays using a high-pressure mercury lamp, thereby obtaining a heat ray shielding film 1.

Meanwhile, when the film thickness was set to 3 μm, the visible light transmittance reached 80% in the measurement described below.

<Measurement of Visible Light Transmittance (VLT) and Solar Transmittance (SLT)> Heat Ray Shielding Film

For the obtained heat ray shielding film 1, using a spectral photometer (V-770, manufactured by JASCO Corporation) and the measurement method according to Japanese Industrial Standards JIS S3107: 2013, the visible light transmittance (VLT) and the solar transmittance (SLT) when the visible light transmittance (VLT) was 80% or more were measured, and SLT/VLT was calculated from the obtained value. The results are shown in Table 3.

<Measurement of Haze Value>

For the obtained heat ray shielding film 1, the haze meter was measured using a haze meter (NDH2000, manufactured by Nippon Denshoku Industries Co., Ltd.) and the measurement method according to Japanese Industrial Standards JIS K 7136: 2000. The result is shown in Table 3.

### Example 2

<Production of Dispersion Liquid 2, Coating Liquid 2, and Heat Ray Shielding Film 2>

A dispersion liquid 2 was obtained in the same manner as the dispersion liquid 1 except for the fact that the crushing and dispersion time using the sand grinder was set to three hours in the production of the dispersion liquid 1. For the obtained dispersion liquid 2, the same measurements as for the dispersion liquid 1 were carried out. The results are shown in Table 1.

A coating liquid 2 was obtained in the same manner as the coating liquid 1 except for the fact that the dispersion liquid 2 was used in the production of the coating liquid 1. For the obtained coating liquid 2, the same measurements as for the coating liquid 1 were carried out. The results are shown in Table 2.

A heat ray shielding film 2 was obtained in the same manner as the heat ray shielding film 1 except for the fact that the coating liquid 2 was used in the production of the heat ray shielding film 1. For the obtained heat ray shielding film 2, the same measurements as for the heat ray shielding film 1 were carried out. The results are shown in Table 3.

### Example 3

<Production of Dispersion Liquid 3, Coating Liquid 3, and Heat Ray Shielding Film 3>

A dispersion liquid 3 was obtained in the same manner as the dispersion liquid 1 except for the fact that the crushing and dispersion time using the sand grinder was set to two hours in the production of the dispersion liquid 1. For the obtained dispersion liquid 3, the same measurements as for the dispersion liquid 1 were carried out. The results are shown in Table 1.

A coating liquid 3 was obtained in the same manner as the coating liquid 1 except for the fact that the dispersion liquid 3 was used in the production of the coating liquid 1. For the obtained coating liquid 3, the same measurements as for the coating liquid 1 were carried out. The results are shown in Table 2.

A heat ray shielding film 3 was obtained in the same manner as the heat ray shielding film 1 except for the fact that the coating liquid 3 was used in the production of the heat ray shielding film 1. For the obtained heat ray shielding film 3, the same measurements as for the heat ray shielding film 1 were carried out. The results are shown in Table 3.

### Example 4

<Production of Dispersion Liquid 4, Coating Liquid 4, and Heat Ray Shielding Film 4>

A dispersion liquid 4 was obtained in the same manner as the dispersion liquid 1 except for the fact that the rotation speed of the sand grinder was set to 2,000 rpm in the production of the dispersion liquid 1. For the obtained dispersion liquid 4, the same measurements as for the dispersion liquid 1 were carried out. The results are shown in Table 1.

A coating liquid 4 was obtained in the same manner as the coating liquid 1 except for the fact that the dispersion liquid 4 was used in the production of the coating liquid 1. For the obtained coating liquid 4, the same measurements as for the coating liquid 1 were carried out. The results are shown in Table 2.

A heat ray shielding film 4 was obtained in the same manner as the heat ray shielding film 1 except for the fact that the coating liquid 4 was used in the production of the heat ray shielding film 1. For the obtained heat ray shielding film 4, the same measurements as for the heat ray shielding film 1 were carried out. The results are shown in Table 3.

### Example 5

<Production of Dispersion Liquid 5, Coating Liquid 5, and Heat Ray Shielding Film 5>

Powder of the antimony-doped tin oxide (ATO) particles 1 (50.0 parts by mass), 3-methacryloxypropyl trimethoxysilane (KBM-503, manufactured by Shin-Etsu Chemical Co., Ltd.) (7.0 parts by mass), and toluene (43.0 parts by mass) were crushed and dispersed using the sand grinder together with glass beads having a diameter of 0.1 mmφ at 2,500 rpm for four hours, thereby obtaining a dispersion liquid 5. For the obtained dispersion liquid 5, the same measurements as for the dispersion liquid 1 were carried out. The results are shown in Table 1.

A coating liquid 5 was obtained in the same manner as the coating liquid 1 except for the fact that the dispersion liquid 5 was used in the production of the coating liquid 1. For the obtained coating liquid 5, the same measurements as for the coating liquid 1 were carried out. The results are shown in Table 2.

A heat ray shielding film 5 was obtained in the same manner as the heat ray shielding film 1 except for the fact that the coating liquid 5 was used in the production of the heat ray shielding film 1. For the obtained heat ray shielding film 5, the same measurements as for the heat ray shielding film 1 were carried out. The results are shown in Table 3.

### Example 6

<Production of Dispersion Liquid 6, Coating Liquid 6, and Heat Ray Shielding Film 6>

A dispersion liquid 6 was obtained in the same manner as the dispersion liquid 1 except for the fact that the ATO particles 1 were changed to ATO particles 2 (manufactured by Sumitomo Osaka Cement Co., Ltd.: the powder characteristics are shown in Table 1) in the production of the dispersion liquid 1. For the obtained dispersion liquid 6, the same measurements as for the dispersion liquid 1 were carried out. The results are shown in Table 1.

A coating liquid 6 was obtained in the same manner as the coating liquid 1 except for the fact that the dispersion liquid 6 was used in the production of the coating liquid 1. For the obtained coating liquid 6, the same measurements as for the coating liquid 1 were carried out. The results are shown in Table 2.

A heat ray shielding film 6 was obtained in the same manner as the heat ray shielding film 1 except for the fact that the coating liquid 6 was used in the production of the heat ray shielding film 1. For the obtained heat ray shielding film 6, the same measurements as for the heat ray shielding film 1 were carried out. The results are shown in Table 3.

### Comparative Example 1

<Production of Dispersion Liquid 7, Coating Liquid 7, and Heat Ray Shielding Film 7>

A dispersion liquid 7 was obtained in the same manner as the dispersion liquid 1 except for the fact that the crushing and dispersion time using the sand grinder was set to 30 minutes (0.5 hours) in the production of the dispersion liquid 1. For the obtained dispersion liquid 7, the same measurements as for the dispersion liquid 1 were carried out. The results are shown in Table 1.

A coating liquid 7 was obtained in the same manner as the coating liquid 1 except for the fact that the dispersion liquid 7 was used in the production of the coating liquid 1. For the obtained coating liquid 7, the same measurements as for the coating liquid 1 were carried out. The results are shown in Table 2.

A heat ray shielding film 7 was obtained in the same manner as the heat ray shielding film 1 except for the fact that the coating liquid 7 was used in the production of the heat ray shielding film 1. For the obtained heat ray shielding film 7, the same measurements as for the heat ray shielding film 1 were carried out. The results are shown in Table 3.

### Comparative Example 2

<Production of Dispersion Liquid 8, Coating Liquid 8, and Heat Ray Shielding Film 8>

Powder of the ATO particles 1 (50.0 parts by mass), aluminum-sec-butylate (3.0 parts by mass), an aromatic phosphoric acid ester surfactant (1.0 parts by mass), and toluene (46.0 parts by mass) were crushed and dispersed using the sand grinder together with glass beads having a diameter of 0.1 map at 2,500 rpm for four hours, thereby obtaining a dispersion liquid 8. For the obtained dispersion liquid 8, the same measurements as for the dispersion liquid 1 were carried out. The results are shown in Table 1.

A coating liquid 8 was obtained in the same manner as the coating liquid 1 except for the fact that the dispersion liquid 8 was used in the production of the coating liquid 1. For the obtained coating liquid 8, the same measurements as for the coating liquid 1 were carried out. The results are shown in Table 2.

A heat ray shielding film 8 was obtained in the same manner as the heat ray shielding film 1 except for the fact that the coating liquid 8 was used in the production of the heat ray shielding film 1. For the obtained heat ray shielding film 8, the same measurements as for the heat ray shielding film 1 were carried out. The results are shown in Table 3.

### Comparative Example 3

<Production of Dispersion Liquid 9, Coating Liquid 9, and Heat Ray Shielding Film 9>

Powder of the ATO particles 1 (50.0 parts by mass), 3-methacryloxypropyl trimethoxysilane (KBM-503, manufactured by Shin-Etsu Chemical Co., Ltd.) (2.0 parts by mass), and toluene (48.0 parts by mass) were crushed and dispersed using the sand grinder together with glass beads having a diameter of 0.1 mg) at 2,500 rpm for four hours, thereby obtaining a dispersion liquid 9. For the obtained dispersion liquid 9, the same measurements as for the dispersion liquid 1 were carried out. The results are shown in Table 1.

A coating liquid 9 was obtained in the same manner as the coating liquid 1 except for the fact that the dispersion liquid 9 was used in the production of the coating liquid 1. For the obtained coating liquid 9, the same measurements as for the coating liquid 1 were carried out. The results are shown in Table 2.

A heat ray shielding film 9 was obtained in the same manner as the heat ray shielding film 1 except for the fact that the coating liquid 9 was used in the production of the heat ray shielding film 1. For the obtained heat ray shielding film 9, the same measurements as for the heat ray shielding film 1 were carried out. The results are shown in Table 3.

### Comparative Example 4

<Production of Dispersion Liquid 10, Coating Liquid 10, and Heat Ray Shielding Film 10>

A dispersion liquid 10 was produced in the same manner as the dispersion liquid 1 except for the fact that the composition was changed as described below in the production of the dispersion liquid 1.

| | | |
|---|---|---|
| ATO particles 2 | 50.0 | parts by mass |
| Aluminum-sec-butylate | 3.0 | parts by mass |
| Aromatic phosphoric acid ester surfactant | 1.0 | parts by mass |
| Toluene | 46.0 | parts by mass |

For the obtained dispersion liquid 10, the same measurements as for the dispersion liquid 1 were carried out. The results are shown in Table 1.

A coating liquid 10 was obtained in the same manner as the coating liquid 1 except for the fact that the dispersion liquid 10 was used in the production of the coating liquid 1. For the obtained coating liquid 10, the same measurements as for the coating liquid 1 were carried out. The results are shown in Table 2.

A heat ray shielding film 10 was obtained in the same manner as the heat ray shielding film 1 except for the fact that the coating liquid 10 was used in the production of the heat ray shielding film 1. For the obtained heat ray shielding film 10, the same measurements as for the heat ray shielding film 1 were carried out. The results are shown in Table 3.

TABLE 1

| | | | Example | | | | | | Comparative Example | | | |
|---|---|---|---|---|---|---|---|---|---|---|---|---|
| | | | 1 | 2 | 3 | 4 | 5 | 6 | 1 | 2 | 3 | 4 |
| Dispersion liquid No. | | | 1 | 2 | 3 | 4 | 5 | 6 | 7 | 8 | 9 | 10 |
| ATO particles | | Content (parts by mass) | 50.0 | 50.0 | 50.0 | 50.0 | 50.0 | 50.0 | 50.0 | 50.0 | 50.0 | 50.0 |
| | | Content (% by mass) | 50 | 50 | 50 | 50 | 50 | 50 | 50 | 50 | 50 | 50 |
| Solvent (toluene) | | Content (parts by mass) | 43.0 | 43.0 | 43.0 | 43.0 | 43.0 | 43.0 | 43.0 | 46.0 | 48.0 | 46.0 |
| Others | Aluminum-sec-butylate (content, | | 5.0 | 5.0 | 5.0 | 5.0 | — | 5.0 | 5.0 | 3.0 | — | 3.0 |
| | parts by mass) | | | | | | | | | | | |
| | Aromatic phosphoric acid ester | | 2.0 | 2.0 | 2.0 | 2.0 | — | 2.0 | 2.0 | 1.0 | — | 1.0 |
| | surfactant (content, parts by | | | | | | | | | | | |
| | mass) | | | | | | | | | | | |
| | 3-Methacryloxypropyl | | — | — | — | — | 7.0 | — | — | — | 2.0 | — |
| | trimethoxysilane (content, parts | | | | | | | | | | | |
| | by mass) | | | | | | | | | | | |
| Properties of | L*a*b* | L* | 52.6 | 52.6 | 52.6 | 52.6 | 52.6 | 61.6 | 52.6 | 52.6 | 52.6 | 61.6 |
| ATO particles | | a* | −4.1 | −4.1 | −4.1 | −4.1 | −4.1 | −3.0 | −4.1 | −4.1 | −4.1 | −3.0 |
| | | b* | −9.7 | −9.7 | −9.7 | −9.7 | −9.7 | −6.0 | −9.7 | −9.7 | −9.7 | −6.0 |

| | | | | | | | | | | |
|---|---|---|---|---|---|---|---|---|---|---|
| Crystallite diameter (nm) | 11.2 | 11.2 | 11.2 | 11.2 | 11.2 | 9.2 | 11.2 | 11.2 | 11.2 | 9.2 |
| BET specific surface area (m²/g) | 72.5 | 72.5 | 72.5 | 72.5 | 72.5 | 84.3 | 72.5 | 72.5 | 72.5 | 84.3 |

| Crushing and | Rotation speed (rpm) | 2.500 | 2.500 | 2.500 | 2.000 | 2.500 | 2.500 | 2.500 | 2.500 | 2.500 | 2.500 |
|---|---|---|---|---|---|---|---|---|---|---|---|
| dispersion conditions | Time (h) | 4 | 3 | 2 | 4 | 4 | 4 | 0.5 | 4 | 4 | 4 |
| Average particle diameter (D50 · nm) | | 57 | 68 | 88 | 85 | 67 | 61 | 129 | 91 | 157 | 86 |
| L*a*b* of dispersion | L* | 8.0 | 10.6 | 12.4 | 11.8 | 9.6 | 10.8 | 15.3 | 13.3 | 16.6 | 13.3 |
| liquid | a* | −0.9 | −1.0 | −1.2 | −1.2 | −1.1 | −1.0 | −1.7 | −1.3 | −1.9 | −1.3 |
| | b* | −10.6 | −12.0 | −12.5 | −12.3 | −11.4 | −10.2 | −12.8 | −12.6 | −13.0 | −9.5 |
| Particle size | D10(rim) | 36 | 39 | 46 | 46 | 40 | 38 | 56 | 51 | 54 | 45 |
| distribution of | D90(nm) | 131 | 161 | 236 | 221 | 160 | 155 | 336 | 264 | 383 | 218 |
| dispersion liquid | D50/D10 | 1.6 | 1.7 | 1.9 | 1.8 | 1.7 | 1.6 | 2.3 | 1.8 | 2.9 | 1.9 |

TABLE 2

| | | Example | | | | | | Comparative Example | | | |
|---|---|---|---|---|---|---|---|---|---|---|---|
| | | 1 | 2 | 3 | 4 | 5 | 6 | 1 | 2 | 3 | 4 |
| Dispersion liquid No. | | 1 | 2 | 3 | 4 | 5 | 6 | 7 | 8 | 9 | 10 |
| Dispersion | Content | 63.0 | 63.0 | 63.0 | 63.0 | 63.0 | 63.0 | 63.0 | 63.0 | 63.0 | 63.0 |
| liquid | (parts by | | | | | | | | | | |
| | mass) | | | | | | | | | | |
| Polymerizable | Content | 22.0 | 22.0 | 22.0 | 22.0 | 22.0 | 22.0 | 22.0 | 22.0 | 22.0 | 22.0 |
| compound | (parts by | | | | | | | | | | |
| (urethane | mass) | | | | | | | | | | |
| acrylate | | | | | | | | | | | |
| resin) | | | | | | | | | | | |
| Others | Photo | 1.0 | 1.0 | 1.0 | 1.0 | 1.0 | 1.0 | 1.0 | 1.0 | 1.0 | 1.0 |
| | initiator | | | | | | | | | | |
| | Toluene | 5.0 | 5.0 | 5.0 | 5.0 | 5.0 | 5.0 | 5.0 | 5.0 | 5.0 | 5.0 |
| | MIBK | 9.0 | 9.0 | 9.0 | 9.0 | 9.0 | 9.0 | 9.0 | 9.0 | 9.0 | 9.0 |
| Content of ATO particles | | 53.5 | 53.5 | 53.5 | 53.5 | 53.5 | 53.5 | 53.5 | 55.2 | 56.5 | 55.2 |
| with respect to | | | | | | | | | | | |
| non-volatile component (% | | | | | | | | | | | |
| by mass) | | | | | | | | | | | |
| (Note 1) Content of ATO | | 30.3 | 30.3 | 30.3 | 30.3 | 30.3 | 30.3 | 30.3 | 29.7 | 29.4 | 29.7 |
| particles (% by mass) | | | | | | | | | | | |
| L*a*b* of | L* | 13.7 | 17.7 | 20.1 | 19.2 | 15.7 | 18.7 | 23.1 | 21.1 | 23.8 | 21.2 |
| dispersion | a* | −1.4 | −2.1 | −2.5 | −2.4 | −1.7 | −2.2 | −3.3 | −2.7 | −3.4 | −2.9 |
| liquid | b* | −12.7 | −13.2 | −13.5 | −13.3 | −13.1 | −12.1 | −12.6 | −13.2 | −12.0 | −11.1 |

(Note 1)
The content (% by mass) of ATO particles with respect to the entire coating liquid when the content of ATO particles is adjusted to 50% by mass of the non-volatile component

TABLE 3

| | Example | | | | | | Comparative Example | | | |
|---|---|---|---|---|---|---|---|---|---|---|
| | 1 | 2 | 3 | 4 | 5 | 6 | 1 | 2 | 3 | 4 |
| Coating liquid No. | 1 | 2 | 3 | 4 | 5 | 6 | 7 | 8 | 9 | 10 |
| Average thickness of heat ray | 3.0 | 3.0 | 3.0 | 3.0 | 3.0 | 3.0 | 3.0 | 3.0 | 3.0 | 3.0 |
| shielding layer (μm) | | | | | | | | | | |
| Visible light transmittance | 80.7 | 80.4 | 80.0 | 80.0 | 80.6 | 80.1 | 66.4 | 79.3 | 46.1 | 80.3 |
| (%)(VLT) | | | | | | | | | | |
| Solar transmittance (%)(SLT) | 65.2 | 64.8 | 64.5 | 63.9 | 65.2 | 64.6 | 55.0 | 63.9 | 39.9 | 66.1 |
| SLT/VLT | 0.81 | 0.81 | 0.81 | 0.80 | 0.81 | 0.81 | 0.90 | 0.81 | 0.96 | 0.82 |
| Haze value (%) | 0.5 | 0.5 | 0.7 | 0.7 | 0.5 | 0.9 | 13.3 | 1.1 | 35.4 | 1.7 |

Meanwhile, for Examples 1 to 6, the values of SLT/VLT when the VLT value is near 80% are shown, and, even when the VLT value is 80% or more, the SLT/VLT value is 0.81 or less.

In addition, when the heat ray shielding films of Comparative Examples 1 to 3 are produced so that the VLT value reaches 80%, uniform films cannot be obtained, and thus the SLT/VLT value in Comparative Examples 1 to 3 are equivalent values when the VLT value is set to 80%.

Based on what has been described above, it is possible to obtain a dispersion liquid and a coating liquid capable of forming a heat ray shielding preliminary film having a low solar transmittance while guaranteeing a high visible light transmittance and a heat ray shielding film having a low solar transmittance while guaranteeing a high visible light transmittance.

1. A dispersion liquid comprising:
antimony-doped tin oxide (ATO) particles; and
a solvent,
wherein a content of the antimony-doped tin oxide particles is 40% by mass or more,
a volume average particle diameter of the antimony-doped tin oxide particles is 90 nm or less,
a particle size distribution of D90/D50 of the antimony-doped tin oxide particles is 2.3 or more and 2.4 or less, and,
in a color space by a L*a*b* color system, an L* value is 13.0 or less, an a* value is −2.0 or more and 0.0 or less, and a b* value is −13.0 or more and −10.0 or less.

2. A coating liquid comprising:
antimony-doped tin oxide (ATO) particles;
a polymerizable compound; and
a solvent,
wherein a content of the antimony-doped tin oxide particles is 40% by mass or more and 60% by mass or less with respect to a non-volatile component,
a particle size distribution of D90/D50 of the antimony-doped tin oxide particles is 2.3 or more and 2.4 or less, and
in a color space by a L*a*b* color system, an L* value is 21.0 or less, an a* value is −3.0 or more and 0.0 or less, and a b* value is −14.0 or more and −12.0 or less.

3. A heat ray shielding film comprising:
antimony-doped tin oxide (ATO) particles,
wherein a particle size distribution of D90/D50 of the antimony-doped tin oxide particles is 2.3 or more and 2.4 or less,
a haze value is 1.0% or less, and,
when a visible light transmittance is 80% or more, a ratio between a solar transmittance (%) and the visible light transmittance (%) (the solar transmittance/the visible light transmittance) is 0.81 or less.
